(19) United States
(12) Patent Application Publication
(10) Pub. No.: US 2025/0163241 A1
(43) Pub. Date: May 22, 2025

(54) ACTIVE ENERGY RAY-CURABLE RESIN COMPOSITION, CURED PRODUCT, LAMINATE ,AND ARTICLE

(71) Applicant: DIC Corporation, Tokyo (JP)

(72) Inventor: Akio Umino, Ichihara-shi (JP)

(73) Assignee: DIC Corporation, Tokyo (JP)

(21) Appl. No.: 18/840,933

(22) PCT Filed: Oct. 27, 2022
(86) PCT No.: PCT/JP2022/040068

§ 371 Date: Aug. 23, 2024

(30) Foreign Application Priority Data
Mar. 8, 2022 (JP) 2022-035075

(51) Int. Cl. C08K 3/36; C08K 3/22; C09D 7/40; C09D 7/61; C09D 133/08

(52) U.S. Cl. CPC C08K 3/36; C08K 3/22; C09D 7/61; C09D 7/67; C09D 133/08; C08K 2003/2244; C08K 2201/005; C08K 2201/011

(57) ABSTRACT

The invention provides an active energy ray-curable resin composition including inorganic fine particles (A), a compound (B) having at least one (meth)acryloyl group in the molecule, a first photoinitiator (C-1), and a second photopolymerization initiator (C-2) having a different structure from the first photopolymerization initiator (C-1), a cured product, a laminate, and an article. The active energy ray-curable resin composition has excellent substrate adhesion and storage stability and also has, when formed into a cured product, excellent scratch resistance and chemical resistance.

### TECHNICAL FIELD

The present invention relates to an active energy ray-curable resin composition, a cured product, a laminate, and an article.

### BACKGROUND ART

A resin material having a (meth)acryloyl group can be easily and instantly cured by active energy ray irradiation, etc., and, in addition, cured products thereof are excellent in transparency, hardness, and the like. Accordingly, such materials have been widely used in the fields of paints, coating agents, and the like. The objects to be coated therewith are diverse, including optical films, plastic molded articles, and woodwork products, for example, and the required performance also varies depending on the kind of object to be coated, the intended use thereof, and the like. Accordingly, a large number of purpose-designed resins have been proposed.

As a resin material having a (meth)acryloyl group, an active energy ray-curable resin composition containing a (meth)acryloyl group-containing acrylic resin, pentaerythritol tetraacrylate, and pentaerythritol triacrylate is known (see, e.g., PTL 1). However, although a cured product of such an active energy ray-curable resin composition has an excellent balance between surface hardness and low cure shrinkage and is useful as a coating agent for coating relatively thin plastic films, there has been a problem in that its adhesion to a film substrate, particularly adhesion after an accelerated lightfastness test simulating actual use situations, is low, and peeling is likely to occur.

Thus, there has been a demand for a material that has excellent substrate adhesion even after an accelerated lightfastness test, and is also excellent in storage stability, scratch resistance, and chemical resistance, allowing for use as a coating agent.

### CITATION LIST

### Patent Literature

PTL 1: JP2011-207947A

### SUMMARY OF INVENTION

### Technical Problem

The problem to be solved by the invention is to provide an active energy ray-curable resin composition having excellent substrate adhesion and storage stability and also having, when formed into a cured product, excellent scratch resistance and chemical resistance, a cured product, a laminate, and an article.

### Solution to Problem

The present inventors have conducted extensive research to solve the above problems. As a result, they have found that the above problems can be solved by using an active energy ray-curable resin composition containing inorganic fine particles, a compound having at least one (meth)acryloyl group in the molecule, and at least two kinds of photoinitiators, and thus accomplished the invention.

That is, the invention encompasses the following aspects.

[1] An active energy ray-curable resin composition including inorganic fine particles (A), a compound (B) having at least one (meth)acryloyl group in the molecule, a first photoinitiator (C-1), and a second photopolymerization initiator (C-2) having a different structure from the first photopolymerization initiator (C-1).

[2] The active energy ray-curable resin composition according to [1], in which the inorganic fine particles (A) have an average particle size within a range of 1 to 150 nm.

[3] The active energy ray-curable resin composition according to [1] or [2], in which the compound (B) is a compound further having a hydroxyl group in the molecule, and the compound (B) has a hydroxyl value within a range of 100 to 300 mgKOH/g.

[4] The active energy ray-curable resin composition according to any of [1] to [3], in which the blending amount of the second photopolymerization initiator (C-2) relative to the blending amount of the first photopolymerization initiator (C-1) [(C-1)/(C-2)] is within a range of 3/1 to 99/1.

[5] The active energy ray-curable resin composition according to any of [1] to [4], in which the first photopolymerization initiator (C-1) is a hydrogen abstraction type photopolymerization initiator, and the second photopolymerization initiator (C-2) is an intramolecular cleavage type photopolymerization initiator.

[6] The active energy ray-curable resin composition according to any of [1] to [5], in which the first photopolymerization initiator (C-1) is benzophenone or 4-methylbenzophenone.

[7] The active energy ray-curable resin composition according to any of [1] to [6], in which the content of the compound (B) is within a range of 10 to 50 mass % based on the total mass of the inorganic fine particles (A) and the compound (B).

[8] The active energy ray-curable resin composition according to any of [1] to [7], in which the inorganic fine particles (A) are silica or zirconium oxide.

[9] The active energy ray-curable resin composition according to any of [1] to [8], in which the compound (B) is a compound having two or more (meth)acryloyl groups in one molecule.

[10] A cured product of the active energy ray-curable resin composition according to any of [1] to [9].

[11] A laminate including a cured coating film of the active energy ray-curable resin composition according to any one of [1] to [9] on one or both surfaces of a substrate.

[12] The laminate according to [11], in which the substrate is a cyclic olefin-based substrate or a linear olefin-based substrate.

[13] The laminate according to or [12], in which the substrate is in the form of a film.

[14] An article including the laminate according to or on a surface thereof.

### Advantageous Effects of Invention

The active energy ray-curable resin composition of the invention is excellent in substrate adhesion, storage stability, scratch resistance, and chemical resistance, and thus can be used as a coating agent or an adhesive. The composition is particularly suitable for use as a coating agent.

### DESCRIPTION OF EMBODIMENTS

The active energy ray-curable resin composition of the invention (hereinafter also referred to simply as “composition”) is characterized by containing inorganic fine particles (A), a compound (B) having at least one (meth)acryloyl group in the molecule, a first photoinitiator (C-1), and a second photoinitiator (C-2) having a different structure from the first photoinitiator (C-1).

Incidentally, in the invention, “(meth)acryloyl” means acryloyl and/or methacryloyl. In addition, “(meth)acrylate” means acrylate and/or methacrylate. Further, “(meth)acrylic” means acrylic and/or methacrylic.

As the inorganic fine particles (A) that can be used in the invention, for example, zirconium oxide, silica, barium sulfate, zinc oxide, barium titanate, cerium oxide, alumina, titanium oxide, niobium oxide, zinc oxide, tin oxide, tungsten oxide, antimony, and the like can be mentioned. These inorganic fine particles can be used alone, and it is also possible to use two or more kinds together. In addition, among them, silica and zirconium oxide are preferable for the reason that an active energy ray-curable resin composition capable of forming a cured product having excellent substrate adhesion and scratch resistance can be obtained.

As commercially available products of the inorganic fine particles (A), for example, IPA-ST, IPA-ST-L, IPA-ST-ZL, EG-ST, PGM-ST, DMAC-ST, MEK-ST-40, MEK-ST-L, MEK-ST-ZL, MIBK-S T, MIBK-ST-L, CHO-ST-M, EAC-ST, PMA-ST, and TOL-ST manufactured by Nissan Chemical Corporation, etc., can be mentioned.

The inorganic fine particles (A) used may have a (meth)acryloyl group on the particle surface. As commercially available products, for example, “MEK-AC-2140Z”, “MEK-AC-4130Y”, “MEK-AC-5140Z”, “PGM-AC-2140Y”, “PGM-AC-4130Y”, “MIBK-AC-2140Z”, and “MIBK-SD-L” manufactured by Nissan Chemical Corporation, “V-8802” and “V-8804” manufactured by JGC Catalysts and Chemicals Ltd., and the like can be mentioned.

In addition, as the inorganic fine particles (A), it is also possible to use wet-dispersed nanosilica obtained by wet-dispersing fumed silica in a wet bead mill or the like, for example.

As the fumed silica, for example, “AEROSIL 7200”, “AEROSIL 8200”, “AEROSIL 9200”, and “AEROSIL #200” manufactured by Nippon Aerosil Co., Ltd., etc., can be mentioned.

These inorganic fine particles (A) can be used alone, and it is also possible to use two or more kinds together.

For the reason that a composition having excellent storage stability and capable of forming a cured product having high substrate adhesion, scratch resistance, and chemical resistance can be obtained, the inorganic fine particles (A) preferably have an average primary particle size within a range of 1 to 150 nm, more preferably within a range of 10 to 140 nm, and particularly preferably within a range of 30 to 120 nm. Incidentally, in the invention, the average primary particle size is obtained by measuring the sizes of a plurality of inorganic fine particles under a transmission electron microscope or a scanning electron microscope and calculating their average.

For the reason that a composition having excellent storage stability and capable of forming a cured product having high substrate adhesion, scratch resistance, and chemical resistance can be obtained, the content of the inorganic fine particles (A) is preferably within a range of 10 to 90 mass %, more preferably within a range of 20 to 80 mass %, and particularly preferably within a range of 30 to 70 mass % of the total mass of the inorganic fine particles (A) and the compound (B).

As the compound (B) having at least one (meth)acryloyl group in the molecule, for example, monofunctional (meth)acrylates such as methoxypolyethylene glycol (meth)acrylate, phenoxydiethylene glycol (meth)acrylate, ethoxylated phenylphenol (meth)acrylate, 2-(meth)acryloyloxyethyl succinate, isobornyl (meth)acrylate, phenylbenzyl (meth)acrylate, phenoxybenzyl (meth)acrylate, 2-hydroxy-3-acryloyloxypropyl (meth)acrylate, phenoxyethylene glycol (meth)acrylate, stearyl (meth)acrylate, and 2-(meth)acryloyloxyethyl succinate;
difunctional (meth)acrylates such as 1,6-hexanediol di(meth)acrylate, 1,4-butanediol di(meth)acrylate, 1,3-butylene glycol di(meth)acrylate, 1,9-nonanediol di(meth)acrylate, 1,10-decanediol di(meth)acrylate, neopentyl glycol di(meth)acrylate, ethylene oxide-modified 1,6-hexanediol di(meth)acrylate, hydroxypivalic acid neopentyl glycol di(meth)acrylate, propylene oxide-modified neopentyl glycol di(meth)acrylate, tripropylene glycol di(meth)acrylate, dipropylene glycol di(meth)acrylate, triethylene glycol di(meth)acrylate, ethylene oxide-modified di(meth)acrylate of bisphenol A, propylene oxide-modified di(meth)acrylate of bisphenol A, ethylene oxide-modified di(meth)acrylate of bisphenol F, tricyclodecane dimethanol di(meth)acrylate, tetraethylene glycol di(meth)acrylate, polyethylene glycol di(meth)acrylate, polypropylene glycol di(meth)acrylate, propylene oxide-modified di(meth)acrylate of glycerin, ethylene oxide-modified di(meth)acrylate of bisphenoxyethanol fluorene, polytetramethylene glycol di(meth)acrylate, ethoxylated isocyanuric acid di(meth)acrylate, trifluoroethyl(meth)acrylate 3-methyl-1,5 pentanediol di(meth)acrylate, 2,3-[(meth)acryloyloxymethyl]norbornane, 2,5-[(meth)acryloyloxymethyl]norbornane, 2,6-[(meth)acryloyloxymethyl]norbornane, 1,3-adamantyl di(meth)acrylate, 1,3-bis[(meth)acryloyloxymethyl]adamantane, tris(hydroxyethyl) isocyanurate di(meth)acrylate, 3,9-bis[1,1-dimethyl-2-(meth)acryloyloxyethyl]-2,4,8,10-tetraoxospiro[5.5]undecane, glycerin diacrylate, trimethylolpropane di(meth)acrylate, pentaerythritol di(meth)acrylate, dipentaerythritol di(meth)acrylate, and ditrimethylolpropane di(meth)acrylate;
trifunctional (meth)acrylates such as glycerin triacrylate, EO-modified glycerol tri(meth)acrylate, PO-modified glycerol tri(meth)acrylate, pentaerythritol tri(meth)acrylate, EO-modified phosphoric acid tri(meth)acrylate, trimethylolpropane tri(meth)acrylate, caprolactone-modified trimethylolpropane tri(meth)acrylate, HPA-modified trimethylolpropane tri(meth)acrylate, (EO)- or (PO)-modified pentaerythritol tri(meth)acrylate, (EO)- or (PO)-modified trimethylolpropane tri(meth)acrylate, alkyl-modified dipentaerythritol tri(meth)acrylate, tris(acryloxyethyl) isocyanurate, and tris(methacryloxyethyl) isocyanurate;
tetrafunctional (meth)acrylates such as ditrimethylolpropane tetra(meth)acrylate, pentaerythritol ethoxytetra(meth)acrylate, pentaerythritol tetra(meth)acrylate, dipentaerythritol tetra(meth)acrylate, and (EO)- or (PO)-modified dipentaerythritol tetra(meth)acrylate;
pentafunctional (meth)acrylates such as dipentaerythritol penta(meth)acrylate, alkyl-modified dipentaerythritol penta(meth)acrylate, and (EO)- or (PO)-modified dipentaerythritol penta(meth)acrylate;
hexafunctional (meth)acrylates such as dipentaerythritol hexa(meth)acrylate and (EO)- or (PO)-modified dipentaerythritol hexa(meth)acrylate; and the like can be mentioned.

Further, as the compound (B) having at least one (meth)acryloyl group in the molecule, dendrimer type (meth)acrylate resins, acrylic (meth)acrylate resins, epoxy (meth)acrylate resins, urethane (meth)acrylate resins, and the like are also usable.

The dendrimer type (meth)acrylate resins are resins having a regular multi-branched structure, with each branched chain having a (meth)acryloyl group at its end. In addition to “dendrimer type”, they are also referred to as “hyperbranched type”, “star polymer”, etc. As commercially available products of the dendrimer type (meth)acrylate resins, for example, “BISCOAT #1000” [weight average molecular weight (Mw): 1,500 to 2,000, average number of (meth)acryloyl groups per molecule: 14], “BISCOAT #1020” [weight average molecular weight (Mw): 1,000 to 3,000], and “SIRIUS 501” [weight average molecular weight (Mw): 15,000 to 23,000]manufactured by Osaka Organic Chemical Industry Ltd., “SP-1106” [weight average molecular weight (Mw): 1,630, average number of (meth)acryloyl groups per molecule: 18]manufactured by Miwon, “CN2301” and “CN2302” [average number of (meth)acryloyl groups per molecule: 16], “CN2303” [average number of (meth)acryloyl groups per molecule: 6], and “CN2304” [average number of (meth)acryloyl groups per molecule: 18]manufactured by SARTOMER, “ESDRIMER HU-22” manufactured by Nippon Steel & Sumikin Chemical Co., Ltd., “A-HBR-5” manufactured by Shin-Nakamura Chemical Co., Ltd., “New Frontier R-1150” manufactured by DKS Co., Ltd., “HYPERTECH UR-101” manufactured by Nissan Chemical Corporation, and the like can be mentioned.

As the acrylic (meth)acrylate resins, for example, those obtained by allowing an acrylic resin intermediate obtained by polymerization using, as an essential component, a (meth)acrylate compound (a) having a reactive functional group such as a hydroxyl group, a carboxyl group, an isocyanate group, or a glycidyl group to further react with a (meth)acrylate compound (B) having a reactive functional group that can react with such functional groups, thereby introducing a (meth)acryloyl group, can be mentioned.

As the (meth)acrylate compound (α) having a reactive functional group, for example, hydroxyl group-containing (meth)acrylate monomers such as hydroxyethyl (meth)acrylate and hydroxypropyl (meth)acrylate; carboxyl group-containing (meth)acrylate monomers such as (meth)acrylic acid; isocyanate group-containing (meth)acrylate monomers such as 2-acryloyloxyethyl isocyanate, 2-methacryloyloxyethyl isocyanate, and 1,1-bis(acryloyloxymethyl)ethyl isocyanate; glycidyl group-containing (meth)acrylate monomers such as glycidyl (meth)acrylate and 4-hydroxybutyl acrylate glycidyl ether; and the like can be mentioned. They can be used alone, and it is also possible to use two or more kinds together.

The acrylic resin intermediate may also be obtained by copolymerizing, in addition to the (meth)acrylate compound (α), other polymerizable unsaturated group-containing compounds as necessary. As the other polymerizable unsaturated group-containing compounds, for example, (meth)acrylic acid alkyl esters such as methyl (meth)acrylate, ethyl (meth)acrylate, propyl (meth)acrylate, butyl (meth)acrylate, and 2-ethylhexyl (meth)acrylate; alicyclic structure-containing (meth)acrylates such as cyclohexyl (meth)acrylate, isoboronyl (meth)acrylate, and dicyclopentanyl (meth)acrylate; aromatic ring-containing (meth)acrylates such as phenyl (meth)acrylate, benzyl (meth)acrylate, and phenoxyethyl acrylate; silyl group-containing (meth)acrylates such as 3-methacryloxypropyltrimethoxysilane; styrene derivatives such as styrene, α-methylstyrene, and chlorostyrene; and the like can be mentioned. They can be used alone, and it is also possible to use two or more kinds together.

The acrylic resin intermediate can be produced in the same manner as for general acrylic resins. As an example of production conditions, for example, it can be produced by polymerizing various monomers in a temperature range of 60° C. to 150° C. in the presence of a polymerization initiator. As polymerization methods, for example, a bulk polymerization method, a solution polymerization method, a suspension polymerization method, an emulsion polymerization method, and the like can be mentioned. In addition, as polymerization forms, for example, random copolymers, block copolymers, graft copolymers, and the like can be mentioned. In the case where a solution polymerization method is employed, for example, ketone solvents, such as methyl ethyl ketone and methyl isobutyl ketone, and glycol ether solvents, such as propylene glycol monomethyl ether, propylene glycol dimethyl ether, propylene glycol monopropyl ether, and propylene glycol monobutyl ether, can be preferably used.

The (meth)acrylate compound (β) is not particularly limited as long as it can react with a reactive functional group that the (meth)acrylate compound (α) has. However, from the viewpoint of reactivity, the following combinations are preferable. That is, in the case where a hydroxyl group-containing (meth)acrylate is used as the (meth)acrylate compound (α), it is preferable to use an isocyanate group-containing (meth)acrylate as the (meth)acrylate compound (β). In the case where a carboxyl group-containing (meth)acrylate is used as the (meth)acrylate compound (α), it is preferable to use a glycidyl group-containing (meth)acrylate as the (meth)acrylate compound (β). In the case where an isocyanate group-containing (meth)acrylate is used as the (meth)acrylate compound (α), it is preferable to use a hydroxyl group-containing (meth)acrylate as the (meth)acrylate compound (β). In the case where a glycidyl group-containing (meth)acrylate is used as the (meth)acrylate compound (α), it is preferable to use a carboxyl group-containing (meth)acrylate as the (meth)acrylate compound (β). The (meth)acrylate compounds (β) can be used alone, and it is also possible to use two or more kinds together.

As a reaction between the acrylic resin intermediate and the (meth)acrylate compound (β), for example, in the case where the reaction is an esterification reaction, a method in which an esterification catalyst such as triphenylphosphine is suitably used in a temperature range of 60 to 150° C., etc., can be mentioned. In addition, in the case where the reaction is a urethane reaction, a method in which the reaction is carried out while adding the compound (β) dropwise to the acrylic resin intermediate in a temperature range of 50 to 120° C., etc., can be mentioned. The reaction ratio between the two is preferably such that the (meth)acrylate compound (β) is used within a range of 1.0 to 1.1 moles per mole of the number of functional groups in the acrylic resin intermediate.

As the epoxy (meth)acrylate resins, for example, those obtained by allowing an epoxy resin to react with (meth)acrylic acid or an anhydride thereof can be mentioned. As the epoxy resin, for example, diglycidyl ethers of dihydric phenols, such as hydroquinone and catechol; diglycidyl ethers of biphenol compounds, such as 3,3′-biphenyldiol and 4,4′-biphenyldiol; bisphenol type epoxy resins such as bisphenol A type epoxy resins, bisphenol B type epoxy resins, bisphenol F type epoxy resins, and bisphenol S type epoxy resins; polyglyceryl ethers of naphthol compounds, such as 1,4-naphthalenediol, 1,5-naphthalenediol, 1,6-naphthalenediol, 2,6-naphthalenediol, 2,7-naphthalenediol, binaphthol, and bis(2,7-dihydroxynaphthyl)methane; triglycidyl ethers such as 4,4,4″-methylidynetrisphenol; novolac type epoxy resins such as phenol novolac type epoxy resins and cresol novolac resins; (poly)oxyalkylene-modified products obtained by introducing a (poly)oxyalkylene chain such as a (poly)oxyethylene chain, a (poly)oxypropylene chain, or a (poly)oxytetramethylene chain into the molecular structure of the above various epoxy resins; lactone-modified products obtained by introducing a (poly)lactone structure into the molecular structure of the above various epoxy resins; and the like can be mentioned.

As the urethane (meth)acrylate resins, for example, reaction products between a polyisocyanate and a compound having a hydroxyl group and a (meth)acryloyl group can be mentioned. As polyisocyanates, for example, aliphatic diisocyanate compounds such as butane diisocyanate, hexamethylene diisocyanate, 2,2,4-trimethylhexamethylene diisocyanate, and 2,4,4-trimethylhexamethylene diisocyanate; alicyclic diisocyanate compounds such as norbornane diisocyanate, isophorone diisocyanate, hydrogenated xylylene diisocyanate, and hydrogenated diphenylmethane diisocyanate; aromatic diisocyanate compounds such as tolylene diisocyanate, xylylene diisocyanate, tetramethylxylylene diisocyanate, diphenylmethane diisocyanate, 1,5-naphthalene diisocyanate, 4,4′-diisocyanato-3,3′-dimethylbiphenyl, and o-tolidine diisocyanate; isocyanurate-modified products, biuret-modified products, and allophanate-modified products thereof; and the like can be used.

As compounds having a hydroxyl group and a (meth)acryloyl group, for example, hydroxyethyl (meth)acrylate, hydroxypropyl (meth)acrylate, trimethylolpropane (meth)acrylate, trimethylolpropane di(meth)acrylate, pentaerythritol (meth)acrylate, pentaerythritol di(meth)acrylate, pentaerythritol tri(meth)acrylate, dipentaerythritol (meth)acrylate, dipentaerythritol di(meth)acrylate, dipentaerythritol tri(meth)acrylate, dipentaerythritol tetra(meth)acrylate, dipentaerythritol penta(meth)acrylate, ditrimethylolpropane (meth)acrylate, ditrimethylolpropane di(meth)acrylate, and ditrimethylolpropane tri(meth)acrylate; as well as (poly)oxyalkylene-modified products obtained by introducing a (poly)oxyalkylene chain such as a (poly)oxyethylene chain, a (poly)oxypropylene chain, or a (poly)oxytetramethylene chain into the molecular structure of these compounds, and lactone-modified products obtained by introducing a (poly)lactone structure into the molecular structure of the above various compounds having a hydroxyl group and a (meth)acryloyl group; and the like can be used.

These compounds (B) having at least one (meth)acryloyl group in the molecule can be used alone, and it is also possible to use two or more kinds together.

Among them, as the compound (B), a compound having at least two (meth)acryloyl groups in one molecule is more preferable. Compared to the case where a monofunctional (meth)acrylate alone is used, the crosslink density after curing improves, and a cured product excellent in scratch resistance and chemical resistance can be obtained.

Further, it is preferable that the compound (B) has a hydroxyl group in the molecule, and the hydroxyl value is preferably within a range of 50 to 500 mg KOH/g, more preferably within a range of 70 to 400 mg KOH/g, and particularly preferably within a range of 100 to 300 mg KOH/g. As the hydroxyl value here, the hydroxyl value refers to the number of milligrams of potassium hydroxide required to neutralize the acetic acid bonded to hydroxyl groups upon acetylation of 1 g of a compound used as the compound (B).

In addition, as the compound (B), a hydroxyl group-containing compound (B-1) and a hydroxyl group-free compound (B-2) may be used together. In this case, the blending ratio of the hydroxyl group-free compound (B-2) to the hydroxyl group-containing compound (B-1) [(B-1)/(B-2)] is preferably within a range of 1/100 to 90/10, more preferably within a range of 1/50 to 50/10, and particularly preferably within a range of 1/10 to 40/10.

As a result of setting the hydroxyl value within these ranges, a composition excellent in storage stability can be obtained, and a cured product obtained by curing the composition is also excellent in substrate adhesion, scratch resistance, and chemical resistance.

For the reason that a composition capable of forming a cured product having excellent substrate adhesion, scratch resistance, and chemical resistance can be obtained, the content of the compound (B) is preferably within a range of 5 to 80 mass %, more preferably within a range of 7 to 65 mass %, and particularly preferably within a range of 10 to 50 mass % based on the total mass of the inorganic fine particles (A) and the compound (B).

Further, the composition of the invention needs to at least contain two kinds of photopolymerization initiators that are different in structure from each other, and the kinds of such photopolymerization initiators are not limited. Two kinds of photopolymerization initiators having different structures are also different in reactivity with the (meth)acrylate compound and the substrate, making it possible to improve scratch resistance, chemical resistance, and substrate adhesion all in a well-balanced manner.

The two kinds of photopolymerization initiators will be described hereinafter, referring to one as a photopolymerization first photoinitiator (C-1), and the other as a second photoinitiator (C-2).

The blending amount of the second photopolymerization initiator (C-2) relative to the blending amount of the first photopolymerization initiator (C-1) [(C-1)/(C-2)] is preferably within a range of 1/1 to 99/1, more preferably within a range of 2/1 to 99/1, and particularly preferably within a range of 3/1 to 99/1. Within these ranges, a cured product of the composition has improved substrate adhesion, scratch resistance, and chemical resistance.

As the first photopolymerization initiator (C-1), a hydrogen abstraction type photopolymerization initiator may be used, for example. Use of a hydrogen abstraction type photopolymerization initiator leads to improved substrate adhesion.

Specifically, benzophenone-based compounds such as benzophenone, 4-methylbenzophenone, methyl o-benzoylbenzoate-4-phenylbenzophenone, 4,4′-dichlorobenzophenone, hydroxybenzophenone, 4-benzoyl-4′-methyl-diphenylsulfide, acrylated benzophenone, 3,3′,4,4′-tetra(t-butylperoxycarbonyl)benzophenone, 3,3′-dimethyl-4-methoxybenzophenone, 2,4,6-trimethylbenzophenone, and 4-methylbenzophenone; thioxanthone-based compounds such as 2-isopropylthioxanthone, 2,4-dimethylthioxanthone, 2,4-diethylthioxanthone, and 2,4-dichlorothioxanthone; xanthone-based compounds such as xanthone, 2-isopropylxanthone, 2,4-dimethylxanthone, 2,4-diethylxanthone, and 2,4-dichloroxanthone; polymers having a benzophenone skeleton, such as polybutylene glycol bis(4-benzoylphenoxy)acetate; and the like can be mentioned. Among them, from the viewpoint of substrate adhesion improvement, benzophenone or 4-methylbenzophenone is more preferable.

These first photopolymerization initiators (C-1) can be used alone, and it is also possible to use two or more kinds together.

As the second photopolymerization initiator (C-2), an intramolecular cleavage type photopolymerization initiator may be used, for example. Use of an intramolecular cleavage type photopolymerization initiator leads to excellent reactivity with the (meth)acrylate compound, whereby the resulting cured product has less unreacted (meth)acrylate compound, and also to improved crosslink density, whereby the scratch resistance of a cured product of the composition improves.

Specifically, 1-hydroxycyclohexyl phenyl ketone, 2-hydroxy-2-methyl-1-phenylpropan-1-one, 1-[4-(2-hydroxyethoxy)phenyl]-2-hydroxy-2-methyl-1-propan-1-one, thioxanthone and thioxanthone derivatives, 2,2′-dimethoxy-1,2-diphenylethan-1-one, diphenyl(2,4,6-trimethoxybenzoyl) phosphine oxide, 2,4,6-trimethylbenzoyldiphenylphosphine oxide, bis(2,4,6-trimethylbenzoyl)phenylphosphine oxide, 2-methyl-1-(4-methylthiophenyl)-2-morpholinopropan-1-one, 2-benzyl-2-dimethylamino-1-(4-morpholinophenyl)-1-butanone, and the like can be mentioned. These second photopolymerization initiators (C-2) can be used alone, and it is also possible to use two or more kinds together.

With respect to the total blending amount of the first photopolymerization initiator (C-1) and the second photopolymerization initiator (C-2), the amount used is preferably within a range of 0.05 to 20 parts by mass, more preferably within a range of 0.1 to 10 parts by mass, and particularly preferably within a range of 1 to 6 parts by mass per 100 parts by mass of the components of the composition of the invention excluding organic solvents. Within these ranges, the storage stability of the composition and the scratch resistance and chemical resistance of a cured product thereof improve, making it possible to prevent the cured product from yellowing.

In addition, the photopolymerization initiators may also be used together with photosensitizers such as amine compounds, urea compounds, sulfur-containing compounds, phosphorus-containing compounds, chlorine-containing compounds, and nitrile compounds.

As long as the effects of the invention are not impaired, in the active energy ray-curable resin composition of the invention, in addition to the compound (B), other active energy ray-curable resin components may also be used. Incidentally, it is preferable that the total content of the inorganic fine particles (A), the compound (B), the first photopolymerization initiator (C-1), and the second photopolymerization initiator (C-2) is 50 mass % or more of the solids of the active energy ray-curable resin composition.

In addition, the active energy ray-curable resin composition of the invention may also contain, as necessary, various additives such as UV absorbers, polymerization inhibitors, antioxidants, organic solvents, inorganic fillers, polymer fine particles, pigments, defoamers, viscosity adjusters, leveling agents, flame retardants, and storage stabilizers.

As the UV absorbers, for example, triazine derivatives such as 2-[4-{(2-hydroxy-3-dodecyloxypropyl)oxy}-2-hydroxyphenyl]-4,6-bis(2,4-dimethylphenyl)-1,3,5-triazine and 2-[4-{(2-hydroxy-3-tridecyloxypropyl)oxy}-2-hydroxyphenyl]-4,6-bis(2,4-dimethylphenyl)-1,3,5-triazine, 2-(2′-xanthenecarboxy-5′-methylphenyl)benzotriazole, 2-(2′-o-nitrobenzyloxy-5′-methylphenyl)benzotriazole, 2-xanthenecarboxy-4-dodecyloxybenzophenone, 2-o-nitrobenzyloxy-4-dodecyloxybenzophenone, and the like can be mentioned. These UV absorbers can be used alone, and it is also possible to use two or more kinds together.

As the polymerization inhibitors, for example, phenol compounds such as p-methoxyphenol, p-methoxycresol, 4-methoxy-1-naphthol, 4,4′-dialkoxy-2,2′-bi-1-naphthol, 3-(N-salicyloyl)amino-1,2,4-triazole, N′1,N′12-bis(2-hydroxybenzoyl) dodecane dihydrazide, styrenated phenol, N-isopropyl-N′-phenylbenzene-1,4-diamine, and 6-ethoxy-2,2,4-trimethyl-1,2-dihydroquinoline, quinone compounds such as hydroquinone, methylhydroquinone, p-benzoquinone, methyl-p-benzoquinone, 2,5-diphenylbenzoquinone, 2-hydroxy-1,4-naphthoquinone, anthraquinone, and diphenoquinone, amine compounds such as melamine, p-phenylenediamine, 4-aminodiphenylamine, N,N′-diphenyl-p-phenylenediamine, N-i-propyl-N′-phenyl-p-phenylenediamine, N-(1,3-dimethylbutyl)-N′-phenyl-p-phenylenediamine, diphenylamine, 4,4′-dicumyl-diphenylamine, 4,4′-dioctyl-diphenylamine, poly(2,2,4-trimethyl-1,2-dihydroquinoline), styrenated diphenylamine, reaction products between styrenated diphenylamine and 2,4,4-trimethylpentene, and reaction products between diphenylamine and 2,4,4-trimethylpentene, thioether compounds such as phenothiazine, distearyl thiodipropionate, 2,2-bis({[3-(dodecylthio)propionyl]oxy}methyl)-1,3-propanediyl=bis[3-(dodecylthio) propionate], and ditridecan-1-yl=3,3′-sulfanediyldipropanoate, nitroso compounds such as N-nitrosodiphenylamine, N-nitrosophenylnaphthylamine, p-nitrosophenol, nitrosobenzene, p-nitrosodiphenylamine, α-nitroso-β-naphthol and the like, N,N-dimethyl p-nitrosoaniline, p-nitrosodiphenylamine, p-nitrosodimethylamine, p-nitroso-N,N-diethylamine, N-nitrosoethanolamine, N-nitrosodi-n-butylamine, N-nitroso-N-n-butyl-4-butanolamine, N-nitroso-diisopropanolamine, N-nitroso-N-ethyl-4-butanolamine, 5-nitroso-8-hydroxyquinoline, N-nitrosomorpholine, N-nitroso-N-phenylhydroxylamine ammonium salts, nitrosobenzene, N-nitroso-N-methyl-p-toluenesulfonamide, N-nitroso-N-ethylurethane, N-nitroso-N-n-propylurethane, 1-nitroso-2-naphthol, 2-nitroso-1-naphthol, sodium 1-nitroso-2-naphthol-3,6-sulfonate, sodium 2-nitroso-1-naphthol-4-sulfonate, 2-nitroso-5-methylaminophenol hydrochloride, and 2-nitroso-5-methylaminophenol hydrochloride, phosphite compounds such as esters of phosphoric acid and octadecan-1-ol, triphenyl phosphite, 3,9-dioctadecan-1-yl-2,4,8,10-tetraoxa-3,9-diphosphaspiro[5.5]undecane, trisnonylphenyl phosphite, phosphorous acid-(1-methylethylidene)-di-4,1-phenylenetetra-C12-15-alkyl esters, 2-ethylhexyl=diphenyl=phosphite, diphenyl isodecyl phosphite, triisodecyl=phosphite, and tris(2,4-di-tert-butylphenyl) phosphite, zinc compounds such as zinc bis(dimethyldithiocarbamato-κ(2) S,S′), zinc diethyldithiocarbamate, and zinc dibutyl·dithiocarbamate, nickel compounds such as bis(N,N-dibutylcarbamodithioato-S,S′) nickel, sulfur compounds such as 1,3-dihydro-2H-benzimidazole-2-thione, 4,6-bis(octylthiomethyl)-o-cresol, 2-methyl-4,6-bis[(octan-1-ylsulfanyl)methyl]phenol, dilauryl thiodipropionate, and distearyl 3,3′-thiodipropionate, and the like can be mentioned. These polymerization inhibitors can be used alone, and it is also possible to use two or more kinds together.

As the antioxidants, the same compounds as those mentioned above as examples of polymerization inhibitors can be used. The antioxidants can be used alone, and it is also possible to use two or more kinds together.

In addition, as commercially available products of the polymerization inhibitors and the antioxidants, for example, “Q-1300” and “Q-1301” manufactured by Wako Pure Chemical Industries, Ltd., “SUMILIZER BBM-S” and “SUMILIZER GA-80” manufactured by Sumitomo Chemical Co., Ltd., and the like can be mentioned.

As the organic solvents, alcohol solvents such as methanol, ethanol, 1-propanol, t-butanol, and diacetone alcohol; alcohol ether solvents such as ethylene glycol monomethyl ether, ethylene glycol monoethyl ether, ethylene glycol monobutyl ether, propylene glycol monomethyl ether, propylene glycol monoethyl ether, carbitol, and cellosolve; ketone solvents such as acetone, methyl ethyl ketone, methyl isobutyl ketone, and cyclohexanone; ester solvents such as methyl acetate, ethyl acetate, and butyl acetate; aromatic solvents such as toluene, xylene, and dibutylhydroxytoluene; and the like can be mentioned. Organic solvents can be used alone, and it is also possible to use two or more kinds together.

As the inorganic fillers, for example, fused silica, crystalline silica, alumina, silicon nitride, aluminum hydroxide, and the like can be mentioned. These inorganic fillers can be used alone, and it is also possible to use two or more kinds together.

As the pigments, known and commonly used inorganic pigments and organic pigments can be used.

As the inorganic pigments, for example, white pigments, antimony red, red iron oxide, cadmium red, cadmium yellow, cobalt blue, Prussian blue, ultramarine blue, carbon black, graphite, and the like can be mentioned. These inorganic pigments can be used alone, and it is also possible to use two or more kinds together.

As the white pigments, for example, titanium oxide, zinc oxide, magnesium oxide, zirconium oxide, aluminum oxide, barium sulfate, silica, talc, mica, aluminum hydroxide, calcium silicate, aluminum silicate, hollow resin particles, zinc sulfide, and the like can be mentioned. These white pigments can be used alone, and it is also possible to use two or more kinds together.

As the organic pigments, for example, quinacridone pigments, quinacridonequinone pigments, dioxazine pigments, phthalocyanine pigments, anthrapyrimidine pigments, anthanthrone pigments, indanthrone pigments, flavanthrone pigments, perylene pigments, diketopyrrolopyrrole pigments, perinone pigments, quinophthalone pigments, anthraquinone pigments, thioindigo pigments, benzimidazolone pigments, azo pigments, and the like can be mentioned. These organic pigments can be used alone, and it is also possible to use two or more kinds together.

As the defoamers, for example, silicone-based defoamers, polyether-based defoamers, fatty acid ester-based defoamers, and the like can be mentioned. These defoamers can be used alone, and it is also possible to use two or more kinds together.

As the viscosity modifiers, for example, acrylic polymers and synthetic rubber latexes that can be thickened through alkaline adjustment, urethane resins that can be thickened through molecular association, hydroxyethyl cellulose, carboxymethyl cellulose, methyl cellulose, polyvinyl alcohol, hydrogenated castor oil, amide wax, oxidized polyethylene, metal soap, dibenzylidene sorbitol, and the like can be mentioned. These viscosity modifiers can be used alone, and it is also possible to use two or more kinds together.

As the leveling agents, for example, silicone-based compounds, acetylene diol-based compounds, fluorine-based compounds, and the like can be mentioned. These leveling agents can be used alone, and it is also possible to use two or more kinds together.

As the flame retardants, for example, inorganic phosphorus compounds such as red phosphorus, ammonium phosphates such as monoammonium phosphate, diammonium phosphate, triammonium phosphate, ammonium polyphosphate, and amide phosphate; organic phosphorus compounds such as phosphate ester compounds, phosphonic acid compounds, phosphinic acid compounds, phosphine oxide compounds, phosphorane compounds, organic nitrogen-containing phosphorus compounds, cyclic organic phosphorus compounds such as 9,10-dihydro-9-oxa-10-phosphaphenanthrene-10-oxide, 10-(2,5-dihydroxyphenyl)-10H-9-oxa-10-phosphaphenanthrene-10-oxide, 10-(2,7-dihydroxynaphthyl)-10H-9-oxa-10-phosphaphenanthrene-10-oxide, and derivatives obtained by allowing them to react with a compound such as an epoxy resin or an phenolic resin; nitrogen-based flame retardants such as triazine compounds, cyanuric acid compounds, isocyanuric acid compounds, and phenothiazine; silicone-based flame retardants such as silicone oil, silicone rubber, and silicone resin; inorganic flame retardants such as metal hydroxides, metal oxides, metal carbonate compounds, metal powders, boron compounds, and low-melting-point glass; and the like can be mentioned. These flame retardants can be used alone, and it is also possible to use two or more kinds together.

The cured product of the invention can be obtained by irradiating the above active energy ray-curable resin composition with active energy rays. As the active energy rays, for example, ionizing radiation such as UV rays, electron beams, α-rays, β-rays, γ-rays can be mentioned. In addition, in the case of using UV rays as the active energy rays, in order to efficiently carry out the UV curing reaction, irradiation may be performed in inert gas atmosphere such as a nitrogen gas or in an air atmosphere.

As a UV-generating source, a UV lamp is generally used from the viewpoint of practicality and economy. Specifically, low pressure mercury lamps, high pressure mercury lamps, ultra-high pressure mercury lamps, xenon lamps, gallium lamps, metal halide lamps, sunlight, LED, and the like can be mentioned.

The total light intensity of the active energy rays is not particularly limited, but is preferably 0.1 to 50 KJ/m², and more preferably 0.3 to 20 kJ/m². When the total light intensity is within the above range, the occurrence of uncured portions can be prevented or suppressed; therefore, this is preferable.

Incidentally, the irradiation with active energy rays can be performed in one step or in two or more steps.

The laminate of the invention has a cured coating film of the above active energy ray-curable resin composition on one or both surfaces of a substrate, and can be obtained by applying the active energy ray-curable resin composition onto the substrate, followed by irradiation with active energy rays to cause curing.

As the substrate, for example, cyclic olefin-based substrates, linear olefin-based substrates, and the like can be mentioned. In addition, the substrate may be in the form of a film.

As methods for forming the cured coating film, for example, a coating method, a transfer method, a sheet bonding method, and the like can be mentioned.

The coating method is a method in which a molded article is coated with the above paint as a top coat by spray coating or, alternatively, using printing equipment such as a curtain coater, a roll coater, or a gravure coater, followed by irradiation with active energy rays to cause curing.

The transfer method is a method in which a transfer material obtained by applying the above active energy ray-curable resin composition onto a base sheet having releasability is bonded to the surface of a molded article, and then the base sheet is peeled off to transfer a top coat to the surface of the molded article, followed by irradiation with active energy rays to cause curing, or a method in which after the transfer material is bonded to the surface of a molded article, active energy ray irradiation is performed to cause curing, and then the base sheet is peeled off to transfer a top coat to the surface of the molded article.

The sheet bonding method is a method in which a protective sheet having a coating film made of the above curable composition on a base sheet, or a protective sheet having a coating film made of a curable composition and a decorative layer on a base sheet, is bonded to a plastic molded article, thereby forming a protective layer on the surface of the molded article.

As such sheet bonding methods, specifically, a method in which a previously prepared base sheet, which serves as a sheet for protective layer formation, and a molded article are bonded together, and then thermally cured by heating and B-staged, thereby crosslinking and curing the resin layer (post-bonding method), a method in which the sheet for protective layer formation is inserted into a molding die, a resin is injected into the cavity to fill the same, and, at the same time as obtaining a resin molded article, the surface thereof and the sheet for protective layer formation are bonded together, and then thermally cured by heating, thereby crosslinking and curing the resin layer (simultaneous molding-bonding method), and the like can be mentioned.

Here, in the case where a cyclic olefin-based substrate or linear olefin-based substrate in film form is used as the substrate, at the time of applying the active energy ray-curable composition of the invention onto the cyclic olefin-based substrate or linear olefin-based substrate in film form, the amount of application is preferably adjusted such that the film thickness after curing is within a range of 1 to 100 μm. In addition, as coating methods at this time, for example, bar coater coating, die coat coating, spray coat coating, curtain coat coating, Meyer bar coating, air knife coating, gravure coating, reverse gravure coating, offset printing, flexographic printing, a screen printing method, and the like can be mentioned. In the case where the active energy ray-curable composition of the invention contains an organic solvent, it is preferable that after the application, warming is performed under 40 to 120° C. conditions for several tens of seconds to several minutes to volatilize the organic solvent, followed by irradiation with active energy rays to cure the active energy ray-curable composition.

The laminate of the invention may have other layer structures in addition to the cured coating film made of the active energy ray-curable resin composition. The method for forming these various layer structures is not particularly limited. For example, a resin raw material may be directly applied to form a layer structure, or it is also possible that a material previously formed into a sheet is attached using an adhesive.

The article of the invention has the above laminate on its surface. As the article, for example, various products including plastic molded articles such as mobile phones, home appliances, automotive interior and exterior materials, and OA appliances can be mentioned.

### EXAMPLES

Hereinafter, the invention will be specifically described through examples and comparative examples. Incidentally, the invention is not limited to the following examples.

Incidentally, in Examples, the weight average molecular weight (Mw) is a value measured using gel permeation chromatography (GPC) under the following conditions.

Measuring apparatus: “HLC-8220” manufactured by Tosoh Corporation

Column: “Guard Column HXL-H” manufactured by Tosoh Corporation
+ “TSKgel G5000HXL” manufactured by Tosoh Corporation
+ “TSKgel G4000HXL” manufactured by Tosoh Corporation
+ “TSKgel G3000HXL” manufactured by Tosoh Corporation
+ “TSKgel G2000HXL” manufactured by Tosoh Corporation

Detector: RI (differential refractometer)

Data processing: “SC-8010” manufactured by Tosoh Corporation

Measurement conditions: Column temperature: 40° C.
Solvent: Tetrahydrofuran
Flow rate: 1.0 ml/min

Standard: Polystyrene

Sample: Tetrahydrofuran solution having a resin solids content of 0.4 mass %, filtered through a microfilter (100 μl)

### Example 1: Preparation of Active Energy Ray-Curable Resin Composition (1)

96.7 parts by mass of silica fine particles (“MEK-ST-ZL” manufactured by Nissan Chemical Corporation, methyl ethyl ketone-dispersed silica sol, primary average particle size: 70 to 100 nm, containing 30 mass % silica), 11.0 parts by mass of glycerol diacrylate (“ARONIX M-920” manufactured by Toagosei Co., Ltd., hydroxyl value: 223 mgKOH/g), 5.0 parts by mass of a mixture of dipentaerythritol pentaacrylate and dipentaerythritol hexaacrylate (“LUMICURE DPA-600” manufactured by Toagosei Co., Ltd.), 5.0 parts by mass of 1,9-nonanediol diacrylate (“BISCOAT #260” manufactured by Osaka Organic Chemical Industry Co., Ltd.), and 1.5 parts by mass of 4-methylbenzyl acrylate (“Omnirad-4MBZ Flakes” manufactured by IGM Resins) were blended, then 0.2 parts by mass of 1-hydroxycyclohexyl phenyl ketone (“Omnirad-184” manufactured by IGM Resins) was blended, and the mixture was diluted with propylene glycol monomethyl ether, thereby giving an active energy ray-curable resin composition (1) having a nonvolatile content of 30 mass %.

### Examples 2 to 8: Preparation of Active Energy Ray-Curable Resin Compositions (2) to (8)

According to the compositions and formulations shown in Tables 1 and 2, active energy ray-curable resin compositions (2) to (8) were obtained in the same manner as in Example 1.

### Comparative Examples 1 to 4: Preparation of Active Energy Ray-Curable Resin Compositions (R1) to (R4)

According to the compositions and formulations shown in Table 2, active energy ray-curable resin compositions (R1) to (R4) were obtained in the same manner as in Example 1.

The solids composition ratios of the active energy ray-curable resin compositions (1) to (8) and (R1) to (R4) obtained in the above examples and comparative examples are shown in Table 1.

TABLE 1

| | | | Example | Example | Example | Example | Example | Example |
|---|---|---|---|---|---|---|---|---|
| | | | 1 | 2 | 3 | 4 | 5 | 6 |
| Active Energy Ray-Curable Resin Composition | | | (1) | (2) | (3) | (4) | (5) | (6) |
| Composition | Inorganic Fine | MEK-ST-ZL | 58 | 58 | | 38 | 58 | 58 |
| (part by mass) | Particles (A) | MEK-ST-40 | | | 58 | | | |
| | | PGM-AC-4130Y | | | | 20 | | |
| | | SZR-GM | | | | | | |
| | Compound (B) | ARONIX M-920 | 22 | 10 | | 22 | 27 | 22 |
| | | ARONIX M-306 | | | 22 | | | |
| | | ARONIX M-309 | | | | | | |
| | | LUMICURE DPA-600T | 10 | 22 | 10 | 10 | 5 | 10 |
| | | BISCOAT #260 | 10 | 10 | 10 | 10 | 10 | 10 |
| | | KRM 8200 | | | | | | |
| | First Photopolymerization | Omnirad-4MBZ | 3 | 3 | 3 | 3 | | 3 |
| | Initiator (C-1) | Omnirad-BP Flakes | | | | | 3 | |
| | Second Photopolymerization | Omnirad-184 | 0.3 | 0.3 | 0.3 | 0.3 | 0.3 | 0.6 |
| | Initiator (C-2) | Omnirad-DETX | | | | | | |

| | | | | | | |
|---|---|---|---|---|---|---|
| Organic Solvent | PGM | PGM | PGM | PGM | PGM | PGM |

| | | | | | | |
|---|---|---|---|---|---|---|
| Nonvolatile Content (mass %) | 30 | 30 | 30 | 30 | 30 | 30 |
| Compound (B)/Total of Inorganic Fine | 28 | 15 | 28 | 32 | 28 | 28 |
| Particles (A) and Compound (B) (mass %) | | | | | | |
| Storage Stability | A | A | A | A | A | A |

TABLE 2

| | | | | | Compar- | Compar- | Compar- | Compar- |
|---|---|---|---|---|---|---|---|---|
| | | | | | ative | ative | ative | ative |
| | | | Exam- | Exam- | Exam- | Exam- | Exam- | Exam- |
| | | | ple | ple | ple | ple | ple | ple |
| | | | 7 | 8 | 1 | 2 | 3 | 4 |
| Active Energy Ray-Curable Resin Composition | | | (7) | (8) | (R1) | (R2) | (R3) | (R4) |
| Composition | Inorganic Fine | MEK-ST-ZL | 48 | 58 | 58 | 58 | 58 | |
| (part by mass) | Particles (A) | MEK-ST-40 | | | | | | |
| | | PGM-AC-4130Y | | | | | | |
| | | SZR-GM | 10 | | | | | |
| | Compound (B) | ARONIX M-920 | 22 | 22 | 22 | 22 | 22 | 20 |
| | | ARONIX M-306 | | | | | | |
| | | ARONIX M-309 | | 5 | | | | |
| | | LUMICURE DPA-600T | 10 | 5 | 10 | 10 | 10 | 10 |
| | | BISCOAT #260 | 10 | 10 | 10 | 10 | 10 | 10 |
| | | KRM 8200 | | | | | | 60 |
| | First Photopolymerization | Omnirad-4MBZ | 3 | 3 | 3 | | | 3 |
| | Initiator (C-1) | Omnirad-BP Flakes | | | | | | |
| | Second Photopolymerization | Omnirad-184 | 0.3 | 0.6 | | 3 | | 0.3 |
| | Initiator (C-2) | Omnirad-DETX | | | | | 3 | |

| | | | | | | |
|---|---|---|---|---|---|---|
| Organic Solvent | PGM | PGM | PGM | PGM | PGM | PGM |

| | | | | | | |
|---|---|---|---|---|---|---|
| Nonvolatile Content (mass %) | 30 | 30 | 30 | 30 | 30 | 30 |
| Compound (B)/Total of Inorganic Fine | 28 | 28 | 60 | 60 | 60 | 60 |
| Particles (A) and Compound (B) (mass %) | | | | | | |
| Storage Stability | A | A | A | A | A | A |

Incidentally, the parts by mass described in Tables 1 and 2 are all values on a solids basis.

“MEK-ST-ZL” in Tables 1 and 2 indicates “MEK-ST-ZL” manufactured by Nissan Chemical Corporation (methyl ethyl ketone-dispersed silica sol, primary average particle size: 70 to 100 nm).

“MEK-ST-40” in Tables 1 and 2 indicates “MEK-ST-40” manufactured by Nissan Chemical Corporation (sol-gel silica, primary average particle size: 12 nm).

“PGM-AC-4130Y” in Tables 1 and 2 indicates “PGM-AC-4130Y” manufactured by Nissan Chemical Corporation (silica fine particles with a methacryloyl group on the particle surface, primary average particle size: 40 to 50 nm).

“SZR-GM” in Tables 1 and 2 indicates “SZR-GM” manufactured by Sakai Chemical Industry Co., Ltd., (zirconia oxide particle dispersion, average particle size: 8 nm, methanol solution).

“ARONIX M-920” in Tables 1 and 2 indicates “ARONIX M-920” manufactured by Toagosei Co., Ltd., (glycerin diacrylate, hydroxyl value: 223 mgKOH/g).

“ARONIX M-306” in Tables 1 and 2 indicates “ARONIX M-306” manufactured by Toagosei Co., Ltd., (reaction product between pentaerythritol and acrylic acid, hydroxyl value: 160 mgKOH/g).

“ARONIX M-309” in Tables 1 and 2 indicates “ARONIX M-309” manufactured by Toagosei Co., Ltd., (trimethylolpropane triacrylate).

“LUMICURE DPA-600” in Tables 1 and 2 indicates “LUMICURE DPA-600” manufactured by Toagosei Co., Ltd., (reaction product between dipentaerythritol and acrylic acid).

“BISCOAT #260” in Tables 1 and 2 indicates “BISCOAT #260” manufactured by Osaka Organic Chemical Industry Co., Ltd., (1,9-nonanediol diacrylate).

“KRM 8200” in Tables 1 and 2 indicates “KRM 8200” manufactured by Daicel-Allnex Ltd., (hexafunctional urethane acrylate).

“Omnirad-4MBZ” in Tables 1 and 2 indicates “Omnirad-4MBZ Flakes” manufactured by IGM Resins (4-methylbenzyl acrylate).

“Omnirad-BP Flakes” in Tables 1 and 2 indicates “Omnirad-BP Flakes” manufactured by IGM Resins (benzophenone).

“Omnirad-184” in Tables 1 and 2 indicates “Omnirad-184” manufactured by IGM Resins (1-hydroxycyclohexyl phenyl ketone).

“Omnirad-DETX” in Tables 1 and 2 indicates “Omnirad-DETX” manufactured by IGM Resins (2,4-diethylthioxanthone).

“PGM” in Tables 1 and 2 indicates propylene glycol monomethyl ether.

### Examples 9 to 16: Preparation of Laminates (L-1) to (L-8)

The active energy ray-curable resin compositions obtained in Examples 1 to 8 were each applied to a 23-μm-thick cycloolefin film substrate (“ZeonorFilm ZF14-023” manufactured by Zeon Corporation, film thickness: 23 μm) using a bar coater, solvent-dried at 80° C. for 40 seconds, and then, in a nitrogen atmosphere, irradiated with UV rays at 1.2 KJ/m² using an 80 W high pressure mercury lamp, thereby giving laminates (L-1) to (L-8) each having a cured coating film having a film thickness of 2 μm on the cycloolefin film.

### Example 17: Preparation of Laminate (L-9)

The active energy ray-curable resin composition obtained in Example 1 was applied to a 23-μm-thick cycloolefin film substrate (“ZeonorFilm ZF14-100” manufactured by Zeon Corporation, film thickness: 100 μm) using a bar coater, solvent-dried at 80° C. for 40 seconds, and then, in a nitrogen atmosphere, irradiated with UV rays at 1.2 kJ/m² using an 80 W high pressure mercury lamp, thereby giving a laminate (L-9) having a cured coating film having a film thickness of 2 μm on the cycloolefin film.

### Comparative Examples 5 to 8: Preparation of Laminates (L-10) to (L-13)

Using the active energy ray-curable resin compositions obtained in Comparative Examples 1 to 4, laminates (L-10) to (L-13) were obtained in the same manner as in the preparation of the laminates (L-1) to (L-8) in Examples 9 to 16.

The following evaluations were performed using the laminates (L-1) to (L-13) obtained in the above examples and comparative examples.

### [Evaluation Method for Substrate Adhesion (Initial)]

Cuts were made in the surface of the cured coating film of the above laminate with a utility knife to create 100 1 mm×1 mm squares in a grid pattern, and a cellophane adhesive tape was attached thereto from above and then quickly peeled off. The number of remaining squares that did not come off was counted, and evaluation was performed according to the following criteria.
A: The number of remaining squares was 90 or more.
B: The number of remaining squares was less than 90.

### Evaluation Method for Substrate Adhesion (after Accelerated Lightfastness Test)

The laminate was irradiated with light for 120 hours at a black panel temperature of 63° C., a humidity of 50% RH, and an irradiance of 60 W/m² using a weather resistance tester (“Atlas Weatherometer CI4000” manufactured by ATRAS). Subsequently, the same procedure as for the substrate adhesion (initial) above was performed, and evaluation was performed according to the following criteria.
A: The number of remaining squares was 90 or more.
B: The number of remaining squares was less than 90.

### [Evaluation Method for Scratch Resistance]

A disk-shaped indenter having a diameter of 2.4 cm was wrapped in 0.5 g of steel wool (“BONSTAR #0000” manufactured by Nihon Steel Wool Co., Ltd.), and, under a load of 1 kg, the indenter was moved back and forth 10 times over the coated surface of the above laminate to perform an abrasion test. The haze value of the laminate was measured before and after the abrasion test using “Haze Computer HZ-2” manufactured by Suga Test Instruments Co., Ltd., and, using their difference value (dH), evaluation was performed according to the following criteria. Incidentally, the smaller the difference value (dH), the higher the resistance to scratching.
A: dH was 1.0 or less.
B: dH was more than 1.0 and 3.0 or less.
C: dH was more than 3.0.

TABLE 3

| | | Exam- | Exam- | Exam- | Exam- | Exam- | Exam- | Exam- | Exam- | Exam- |
|---|---|---|---|---|---|---|---|---|---|---|
| | | ple | ple | ple | ple | ple | ple | ple | ple | ple |
| | | 9 | 10 | 11 | 12 | 13 | 14 | 15 | 16 | 17 |
| Laminate | | (L-1) | (L-2) | (L-3) | (L-4) | (L-5) | (L-6) | (L-7) | (L-8) | (L-9) |
| Active Energy Ray-Curable Resin Composition | | (1) | (2) | (3) | (4) | (5) | (6) | (7) | (8) | (1) |
| Kind of Substrate | | Sub- | Sub- | Sub- | Sub- | Sub- | Sub- | Sub- | Sub- | Sub- |
| | | strate | strate | strate | strate | strate | strate | strate | strate | strate |
| | | 1 | 1 | 1 | 1 | 1 | 1 | 1 | 1 | 2 |
| Evaluation | Substrate Adhesion (Initial) | A | A | A | A | A | A | A | A | A |
| Criteria | Substrate Adhesion (after | A | A | A | A | A | A | A | A | A |
| | Accelerated Lightfastness Test) | | | | | | | | | |
| | Scratch Resistance | A | A | A | A | A | A | A | A | A |
| | Chemical Resistance | A | A | A | A | A | A | A | A | A |

TABLE 4

| | | Comparative | Comparative | Comparative | Comparative |
|---|---|---|---|---|---|
| | | Example | Example | Example | Example |
| | | 5 | 6 | 7 | 8 |
| Laminate | | (L-10) | (L-11) | (L-12) | (L-13) |
| Active Energy Ray-Curable Resin Composition | | (R1) | (R2) | (R3) | (R4) |
| Kind of Substrate | | Substrate 1 | Substrate 1 | Substrate 1 | Substrate 1 |
| Evaluation | Substrate Adhesion (Initial) | A | B | B | B |
| Criteria | Substrate Adhesion (after | A | B | B | B |
| | Accelerated Lightfastness Test) | | | | |
| | Scratch Resistance | C | A | A | A |
| | Chemical Resistance | B | A | B | A |

“Substrate 1” in Tables 3 and 4 indicates “ZeonorFilm ZF14-023” (film thickness: 23 μm) manufactured by Zeon Corporation.

“Substrate 2” in Table 3 indicates “ZeonorFilm ZF14-100” (film thickness: 100 μm) manufactured by Zeon Corporation.

Examples 9 to 17 shown in Table 3 are examples of laminates using the active energy ray-curable composition of the invention. These laminates were found to be excellent in terms of initial substrate adhesion and substrate adhesion after an accelerated lightfastness test, and also found to have, when formed into a cured product, excellent scratch resistance and chemical resistance.

Meanwhile, Comparative Examples 5 to 7 shown in Table 4 are examples of laminates using an active energy ray-curable composition free of either the first photopolymerization initiator (C-1) or the second photopolymerization initiator (C-2). The laminate obtained in Comparative Example 5 was insufficient in terms of scratch resistance and chemical resistance when formed into a cured product. The laminates obtained in Comparative Example 6 and 7 were insufficient in terms of initial substrate adhesion and substrate adhesion after an accelerated lightfastness test, and in the laminate obtained in Comparative Example 7, the chemical resistance when formed into a cured product also decreased.

Comparative Example 8 is an example of a laminate using an active energy ray-curable composition free of the inorganic fine particles (A). This laminate was found to be insufficient in terms of initial substrate adhesion and substrate adhesion after an accelerated lightfastness test.

1. An active energy ray-curable resin composition comprising inorganic fine particles (A), a compound (B) having at least one (meth)acryloyl group in the molecule, a first photoinitiator (C-1), and a second photopolymerization initiator (C-2) having a different structure from the first photopolymerization initiator (C-1).

2. The active energy ray-curable resin composition according to claim 1, wherein the inorganic fine particles (A) have an average particle size within a range of 1 to 150 nm.

3. The active energy ray-curable resin composition according to claim 1, wherein the compound (B) is a compound further having a hydroxyl group in the molecule, and the compound (B) has a hydroxyl value within a range of 100 to 300 mgKOH/g.

4. The active energy ray-curable resin composition according to claim 1, wherein the blending amount of the second photopolymerization initiator (C-2) relative to the blending amount of the first photopolymerization initiator (C-1) [(C-1)/(C-2)] is within a range of 3/1 to 99/1.

5. The active energy ray-curable resin composition according to claim 1, wherein the first photopolymerization initiator (C-1) is a hydrogen abstraction type photopolymerization initiator, and the second photopolymerization initiator (C-2) is an intramolecular cleavage type photopolymerization initiator.

6. The active energy ray-curable resin composition according to claim 1, wherein the first photopolymerization initiator (C-1) is benzophenone or 4-methylbenzophenone.

7. The active energy ray-curable resin composition according to claim 1, wherein the content of the compound (B) is within a range of 10 to 50 mass % based on the total mass of the inorganic fine particles (A) and the compound (B).

8. The active energy ray-curable resin composition according to claim 1, wherein the inorganic fine particles (A) are silica or zirconium oxide particulate.

9. The active energy ray-curable resin composition according to claim 1, wherein the compound (B) is a compound having two or more (meth)acryloyl groups in one molecule.

10. A cured product of the active energy ray-curable resin composition according to claim 1.

11. A laminate comprising a cured coating film of the active energy ray-curable resin composition according to claim 1 on one or both surfaces of a substrate.

12. The laminate according to claim 11, wherein the substrate is a cyclic olefin-based substrate or a linear olefin-based substrate.

13. The laminate according to claim 11, wherein the substrate is in the form of a film.

14. An article comprising the laminate according to claim 12 on a surface thereof.

15. A cured product of the active energy ray-curable resin composition according to claim 2.

16. A cured product of the active energy ray-curable resin composition according to claim 3.

17. A cured product of the active energy ray-curable resin composition according to claim 4.

18. A laminate comprising a cured coating film of the active energy ray-curable resin composition according to claim 2 on one or both surfaces of a substrate.

19. A laminate comprising a cured coating film of the active energy ray-curable resin composition according to claim 3 on one or both surfaces of a substrate.

20. An article comprising the laminate according to claim 13 on a surface thereof.
